(19) United States
(12) Patent Application Publication
(10) Pub. No.: US 2026/0244957 A1
(43) Pub. Date: Aug. 20, 2026

(54) EVENT-HANDLING SUPPORT SYSTEM

(71) Applicants: IncidentTech Inc., Tokyo (JP); NTT DATA Japan Corporation, Tokyo (JP)

(72) Inventor: Koji NOMURA, Tokyo (JP)

(21) Appl. No.: 19/461,648

(22) Filed: Jan. 27, 2026

(30) Foreign Application Priority Data
Feb. 20, 2025 (JP) 2025-025914

(51) Int. Cl. G06N 5/04

(52) U.S. Cl. CPC G06N 5/041

(57) ABSTRACT

An event-handling support system 1 detects an event which occurred in a target system 2, continuously receives user communication messages exchanged among user terminals 7 to 9, executes language analysis thereon and continuously recognizes a situation after occurrence of the event, prepares a hypothesis of a cause of the event which occurred on the basis of a recognition result, calculates and updates a correct-answer probability that the hypothesis is a correct answer, notifies the user of the hypothesis and the correct-answer probability, proposes an additional action which is useful for narrowing to a correct answer from the hypotheses, and notifies the user of the narrowed correct answer and the measure associated thereto.

### BACKGROUND

The present invention relates to an event-handling support system for supporting the handling of an event (an incident, an accident, an inquiry, a case or an accident, for example) which occurred in a target system (any type of system including various service-providing systems such as a financial service, a transaction service and the like, technical systems such as a natural disaster, medical services, plants, facilities, machinery and the like, social systems such as business, traffic, organization, transactions and the like or natural systems such as natural environments, animals / plants, universe, human bodies and the like, for example).

Japanese Patent Application Publication No. 2023-179110 and Japanese Patent Application Publication No. 2008-172707, for example, disclose arts related to support for handling when a failure occurs in a system.

Japanese Patent Application Publication No. 2023-179110 describes a failure-handling support device which performs state monitoring of a network and a server device, and when a failure is detected by the state monitoring, calculates a degree of emergency of handling of the failure on the basis of presence / absence of an access by a user since the time of the occurrence of the failure to the present. This device determines a degree of priority of the failure on the basis of the calculated degree of emergency and presents a determination result of the degree of priority to a maintenance staff.

Japanese Patent Application Publication No. 2008-172707 describes a failure-handling management system having a network monitoring function for monitoring a state of a network and detecting occurrence of a failure. When a network failure is detected by the network monitoring function, this system gives a notification, to a mobile phone in the system, that a network failure has occurred. In addition, this system grasps progress of a failure-recovery handling process on the basis of information recorded in a database, and when there is a problem in the progress state, by using all or some of mobile phones in the system and gives an instruction to solve the problem.

### SUMMARY

When an event occurs in a target system, a series of processes of: collecting information which is helpful to identify the cause; preparing, as hypotheses, several causes with a possibility; and narrowing the prepared hypotheses to one correct cause, is required.

There is a problem in that accurate execution of such a process in a short time at a site is difficult for those other than considerably skilled staff.

Japanese Patent Application Publication No. 2023-179110 and Japanese Patent Application Publication No. 2008-172707 do not disclose sufficient solutions to these problems.

An object of the present invention is to provide an event-handling support system that, when an event occurs, anyone, not only a skilled staff, can perform a series of works of accurately collecting information which has to be collected and of identifying a cause from the result rapidly and without an error as much as possible.

Another object of the present invention will be made apparent from the disclosure below.

An event-handling support system according to an embodiment includes a communication module constituted to communicate with a user terminal used by a user, a detection module constituted to detect an event which occurred in a target system, an analysis module constituted to receive a message of the user from the user terminal and to execute language analysis on the received message, a data collection module for collecting data which can be used for investigating a cause of the event which occurred, a hypothesis module for preparing one or more hypotheses indicating one or more causes with a possibility of causing the event, which occurred, by using the collected data and a result of the language analysis on the message, and a user interface (UI) module for notifying the user of occurrence of the event and the one or more hypotheses.

According to the above-described constitution, one or more hypotheses of the causes with a possibility of causing the event which occurred can be set and notified to the user.

An event-handling support system according to the embodiment is constituted to include an additional action module constituted to identify one or more additional actions which are helpful to narrow the one or more hypotheses to one correct solution and a proposing module constituted to prepare a first proposal including presentation of the one or more identified additional actions, in which the UI module notifies the user of the first proposal.

According to the above-described constitution, it is possible to propose to a user one or more additional actions which are helpful to narrow to a correct answer from one or more hypotheses.

An event-handling support system according to the embodiment is constituted to include a probability module constituted to calculate a correct-answer probabilities of the one or more hypotheses, and the UI module notifies the user of the correct-answer probabilities of the one or more hypotheses.

According to the above-described constitution, not only the prepared hypotheses but also correct answer probabilities thereof can be notified to the user.

According to the event-handling support system according to the embodiment, it is constituted such that, when the analysis module receives a new message indicating a result of an additional action performed by the user from the user terminal, language analysis on the new message is executed, the result of the performed additional action is recognized, and the probability module executes re-calculation of correct-answer probabilities of the one or more hypotheses by using the recognized result, and the UI module updates the correct-answer probability of the one or more hypotheses notified to the user in accordance with the result of the re-calculation.

According to the above-described constitution, in accordance with the result of the additional action performed by the user, the correct-answer probability of the hypothesis is updated and notified to the user.

According to an event-handling support system according to the embodiment, it is constituted such that, when the analysis module receives a new message indicating a result of an additional action performed by the user from the user terminal, language analysis on the new message is executed, and the result of the performed additional action is recognized, the probability module re-calculates correct-answer probabilities of the one or more hypotheses by using the recognized result, and the proposing module determines whether the correct-answer probabilities of one or more hypotheses calculated by the probability module satisfy a predetermined condition, and when the determination result is positive, one correct answer is estimated from the one or more hypotheses, and a second proposal including presentation of the estimated one correct answer is created, and the UI module notifies the user of the second proposal.

According to the above-described constitution, while the correct-answer probability of hypotheses is updated in response to arrival of a new message from the user, on the basis of the updated correct-answer probability, one correct answer can be estimated from hypotheses and can be proposed to the user.

The event-handling support system according to the embodiment includes the probability module constituted to calculate a correct-answer probability of the one or more hypotheses, the UI module is constituted to notify the user the correct-answer probability of the one or more hypotheses, and the probability module is constituted to predict how the correct-answer probability will be changed, when a result of each execution of the one or more additional actions is obtained, and the proposing module is constituted to add presentation of the predicted change of the correct-answer probability to the first proposal.

According to the above-described constitution, not only the additional action but also how the correct-answer probability of the hypothesis would be changed when the respective additional actions are performed can be proposed to the user.

The event-handling support system according to the embodiment includes a score module constituted to calculate a score of an effect for specifying the correct answer from the one or more hypotheses of each of the one or more additional actions, and the proposing module is constituted to add the presentation of each of the scores of the one or more additional actions to the first proposal.

According to the above-described constitution, to the user, not only the additional action but also what degree of effects each of the additional actions has on the narrowing to the correct answer can be proposed.

According to an event-handling support system according to the embodiment, it is constituted such that, when the analysis module receives a new message illustrating a result of the additional action performed by the user from the user terminal, it executes language analysis on the new message and recognizes the result of the performed additional action, and the probability module recalculates the correct-answer probabilities of the one or more hypotheses by using the recognized result, the proposing module determines whether the correct-answer probabilities of the one or more hypotheses calculated by the probability module satisfy a predetermined condition, and when the determination result is positive, estimates one correct answer from the one or more hypotheses, and prepares the second proposal including presentation of the estimated one correct answer, and the UI module notifies the user the second proposal.

According to the above-described constitution, occurrence of an event, a hypothesis for a cause of the event which occurred, a proposal of an additional action which will help narrowing to a correct answer from those hypotheses, and a proposal of a narrowed correct answer can be notified to a user.

According to an event-handling support system according to the embodiment, the UI module is constituted to provide, to the user terminal, GUI including display of a chart expressing an event-handling process, and the chart has first, second, third, and fourth layers, in which the first layer displays a fact that the occurrence of an event is detected, the second layer lists a plurality of additional actions with a probability which would help finding of a cause of the event which occurred, the third layer lists a plurality of the hypotheses related to the cause with a probability to cause the event which occurred, and the fourth layer lists one or more measures related to each of the plurality of listed hypotheses.

According to the above-described constitution, by providing the GUI displaying the chart of the event-handling process expressed in the above-described four layers to the user, in order to handle the event which occurred, what the additional action with a probability is, what the hypothesis for a cause with a probability is, and what is a measure with a probability can be notified to the user.

According to the event-handling support system according to the embodiment, it is constituted such that, when the one or more hypotheses are prepared, the UI module displays the one or more prepared hypotheses on the third layer, when the result of the additional action performed by the user is recognized, the UI module displays the performed additional action on the second layer, when one hypothesis estimated to be a correct answer is selected by the user from the one or more hypotheses, the UI module displays the selected one hypothesis on the third layer, and when one or more measures are executed by the user, the UI module displays the executed one or more measures on the fourth layer.

According to the above-described constitution, actual progress of the event-handling process can be notified to the user.

According to the event-handling support system according to the embodiment, it is constituted such that the UI module provides, to the user terminal, the GUI including display of a message of the user from the user terminal.

According to the above-described constitution, what message the user input in order to handle the event can be notified to the user.

According to the event-handling support system according to the embodiment, it is constituted such that the UI module provides, to the user terminal, the GUI including the display of a result of the language analysis on the message of the user.

According to the above-described constitution, the result of the language analysis on the message input by the user (various information items related to target events included in those messages, for example) can be notified to the user.

### BRIEF DESCRIPTION OF THE DRAWINGS

FIG. 1 is a block diagram illustrating a functional configuration example of an event-handling support system according to an embodiment of the present invention;

FIG. 2 is a block diagram illustrating a hardware configuration example of an event-handling support system according to an embodiment of the present invention;

FIG. 3 is a diagram illustrating an example of GUI;

FIG. 4 is a diagram illustrating an example of a database;

FIG. 5 is a diagram illustrating an example of a proposal screen;

FIG. 6 is a flowchart illustrating a processing process for event detection and interpretation of inter-user messages executed by the event-handling support system according to the embodiment;

FIG. 7 is a flowchart illustrating a processing process for investigating a cause of occurrence of an event executed by the event-handling support system according to the embodiment;

FIG. 8 is a flowchart illustrating a processing process for presenting progress of event handling executed by the event-handling support system according to the embodiment to a user;

FIG. 9 illustrates an example of a template displaying a handling-process frame of the GUI;

FIG. 10 illustrates a display example of the handling-process frame of the GUI (at event detection);

FIG. 11 illustrates a display example of the handling- process frame of the GUI (at hypotheses preparing);

FIG. 12 illustrates a display example of the handling- process frame of the GUI (at additional action result input);

FIG. 13 illustrates a display example of the handling- process frame of the GUI (at hypothesis selection); and

FIG. 14 illustrates a display example of the handling- process frame of the GUI (at measure selection).

### DETAILED DESCRIPTION OF THE EMBODIMENT

Hereinafter, embodiments will be explained with reference to the drawings. These embodiments are exemplary for explaining the present invention and are omitted and simplified as appropriate for clarifying the explanation. In addition, the present invention is not limited to these embodiments, but all the applications matching the idea of the present invention are included in a technical range of the present invention.

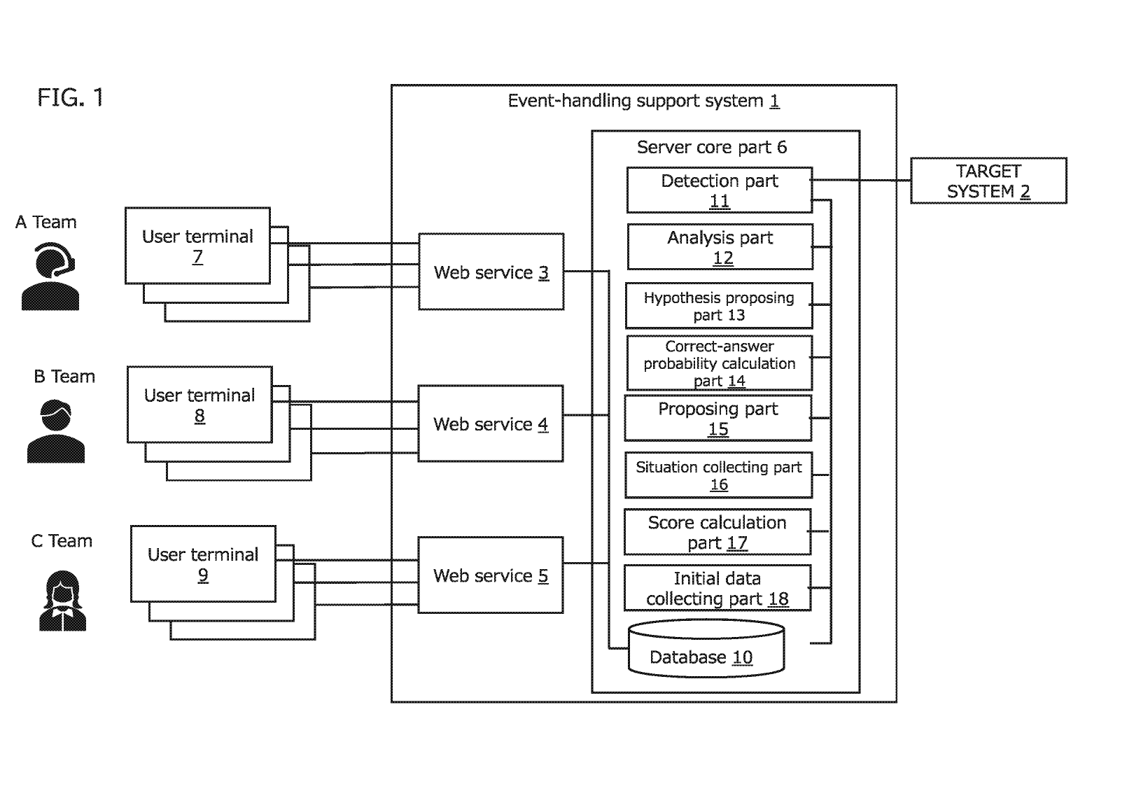

FIG. 1 is a block diagram illustrating an outline configuration of an event-handling support system according to an embodiment of the present invention. The event-handling support system 1 (hereinafter, abbreviated as a system 1 in some cases) is for supporting handling of an event which occurred in a target system 2 and includes Web servicesWeb services 3 to 5 and a server core part 6. It is to be noted that FIG. 1 illustrates that the system 1 is constituted by one unit of a computer machine, but the system 1 may be realized by a plurality of units of computer machines.

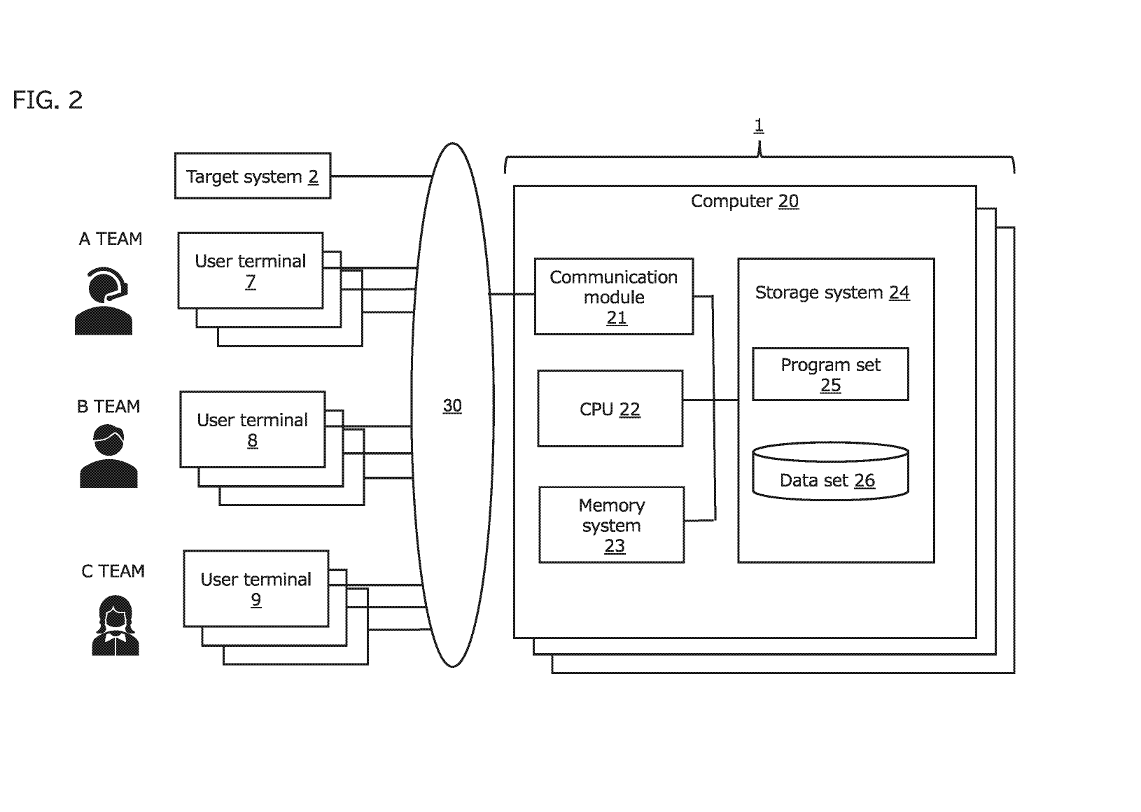

FIG. 2 illustrates an example of a hardware configuration of the event-handling support system 1. As shown in FIG. 2, the event-handling support system 1 can include one or a plurality of computers 20. The computer 20 has a communication module 21, a processor (CPU, for example) 22, a memory system 23, a storage system 24. In the storage system 24, a program set 25 and a data set 26 managed by a database 10 (FIG. 1) are accommodated. The communication module 21 communicates with one or a plurality of user terminals 7 to 9 via a communication network 30, for example. When the program set 25 is loaded in the memory system 23 and is executed by the processor 22, the program set 25 orders the processor 22 to operate as a plurality of processing modules shown in FIG. 1, that is, the Web servicesWeb services 3 to 5 and processing units 10 to 18 of the server core part 6.

With reference to FIG. 1, one or the plurality of Web servicesWeb services 3 to 5 provide the GUI ((Graphical User Interface) to one or the plurality of user terminals 7 to 9, respectively. Each of the user terminals 7 to 9 can be an information processing device such as a smartphone, a tablet terminal, a personal computer or the like. The plurality of user terminals 7 to 9 can have roles different from each other or can be used by a plurality of users belonging to different companies or organizations. For example, one or more user terminals 7 are operated by members of an A team (organization or business) which operates and manages the target system 2. Another one or more user terminals 8 are operated by members of a B team (organization or business) which provides a customer service to end users who use the target system 2, for example. Still another one or more user terminals 9 are operated by members of a C team (organization or business) which executes designing or maintenance of the target system 2, for example.

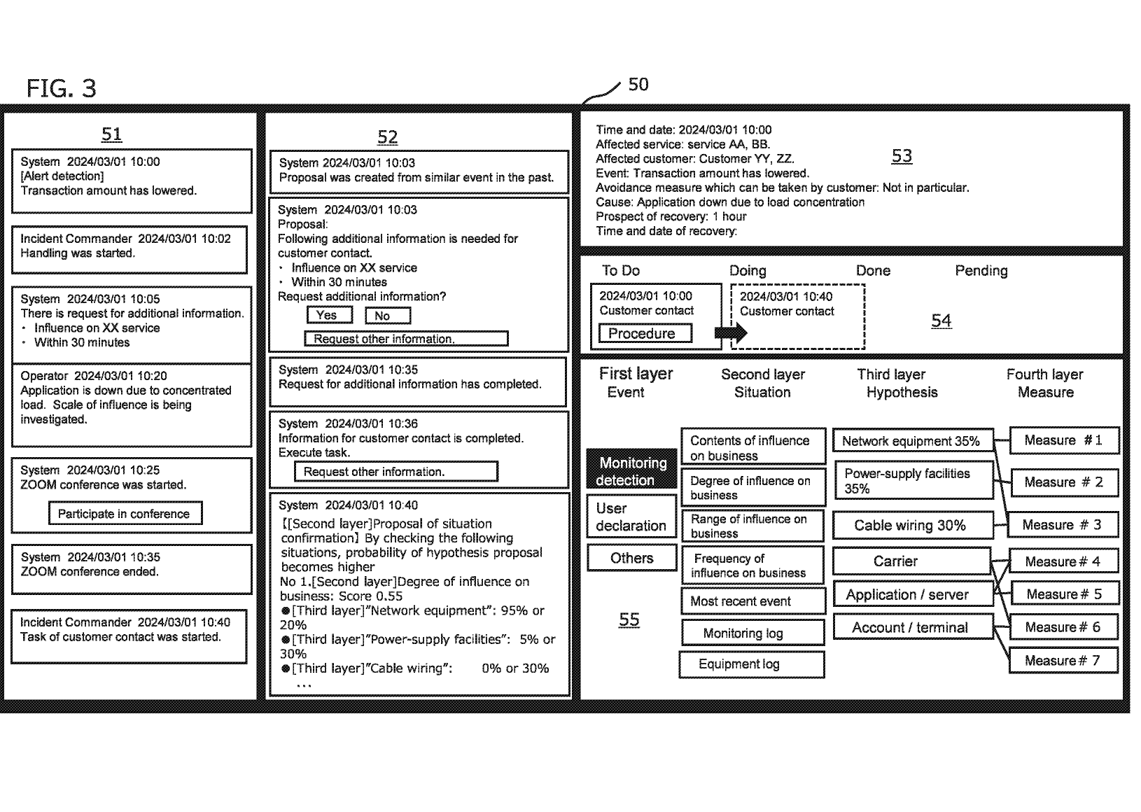

The plurality of Web servicesWeb services 3 to 5 provide contents of data accumulated in the database 10, which will be described later, in the GUI having different configuration designs or layouts matching the roles of the respective members or teams to the user terminals 3 to 5 of the plurality of members with different roles as described above. FIG. 3 illustrates an example of the GUI displayed to the members of the above-described A team which operates the target system 2. In a GUI 50 exemplified in FIG. 3, a situation which is continuously changing in relation with a detected event is expressed in an expression format including exchanged messages among the users, proposal messages from the system to a user, a plurality of information items indicating details of the situation related to the event (an event, an affected service, an affected customer, a cause, a measure, prospect, related knowledge, To Do task, Doing task, Done task, a user in charge of the task, a user who can handle and the like) and progress of a handling process from detection of the event to execution of the measure.

More specifically, the GUI 50 includes an inter-user communication frame 51, a system-proposing frame 52, an information-item frame 53, a task frame 54, and a handling-process frame 55. The inter-user communication frame 51 displays natural-language messages output from the user terminals 7 to 9 (exchanged among the user terminals 7 to 9), received by the event-handling support system 1 and exchanged among the users in a text-chat format, for example. The system-proposing frame 52 displays the proposal for users automatically generated by the event-handling support system 1 in a text message format in the natural language.

Each of the Web servicesWeb services 3 to 5 makes it possible that each user type-inputs a message in the natural language in the inter-user communication frame 51 from the respective user terminals 7 to 9. Each of the Web servicesWeb services 3 to 5 displays the message input from each user in a text format in the inter-user communication frame 51 and stores it in the database 10. Each of the Web servicesWeb services 3 to 5 can recognize a voice message input via a microphone from each of the users, convert it to text data and handle it similarly to the type-input messages. Moreover, when an online videoconference is held among the users, each of the Web services 3 to 5 can make an access to the online conference (participate in the conference, for example), convert voice data exchanged among the users in the conference to the text data and handle it similarly to the above. As a result, the inter-user communication frame 51 on the GUI 50 displays discussion among the users substantially on the real-time basis. Each user can grasp progress of the discussion among the users by referring to the inter-user communication frame 51.

With respect to the information-item frame 53 in the GUI 50, the event-handling support system 1 displays the plurality of information items (events, affected services, affected customers, causes, measures, prospects, related knowledge, users capable of handling them or the like, for example) classified by interpreting the communication messages among the users in a list format, for example, with regard to the detected event. The task frame 54 displays, in relation with one or more tasks in the above-described information items, detailed items such as the To Do task, the Doing task, the Done task, a Pending task, a user in charge of task and the like in a chart format such as a block diagram, for example.

The handling-process frame 55 in the GUI 50 displays progress of the process which handles the detected event (including stages such as detection of an event, grasping of a situation, preparing of a hypothesis for a cause, identification of a cause, selection of a measure and the like and hereinafter, referred to as an "event-handling process") in a chart format such as a block diagram, for example. The handling-process frame 55 has, as shown in FIG. 3, for example, columns of four layers of an "event", "situation", "hypothesis", and a "measure" in an order from the left to the right along a flow of the event-handling process.

The column of the first layer "event" in the handling-process frame 55 indicates that occurrence of an event has been detected, and there are a plurality of methods for detecting occurrence of an event, and there are blocks such as "monitoring detection", "user declaration", and "others", for example. When occurrence of an event is detected, one block indicating a detection method thereof is lighted or highlighted. In an example shown in FIG. 3, the "monitoring detection" (lighting or highlighting, for example) which means that an event was detected by automatic monitoring of the target system 2 by the system 1 is displayed.

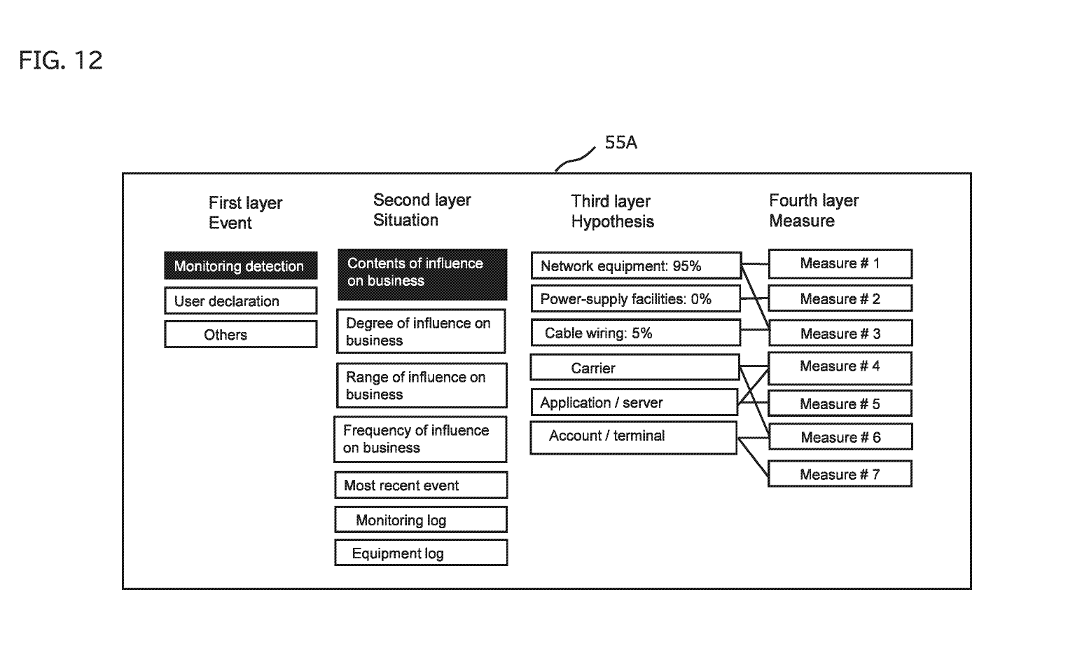

The column of the second layer "situation" in the handling-process frame 55 indicates one or more situation items collected by the user with respect to the event which occurred. In this column, there are blocks indicating a collectable plurality of situation items with a probability of helping cause investigation of the event which occurred such as "contents of influence on business", "degree of influence on business" "range of influence on business", "frequency of influence on business", "most recent event", and various "logs" such as "monitoring log", "equipment log" and the like. When the user collects data of a specific situation item (that is, when the message from the user indicating the fact is received and recognized by the event-handling support system 1), the block of the corresponding situation item is displayed (lighted or highlighted, for example) (see FIG. 12).

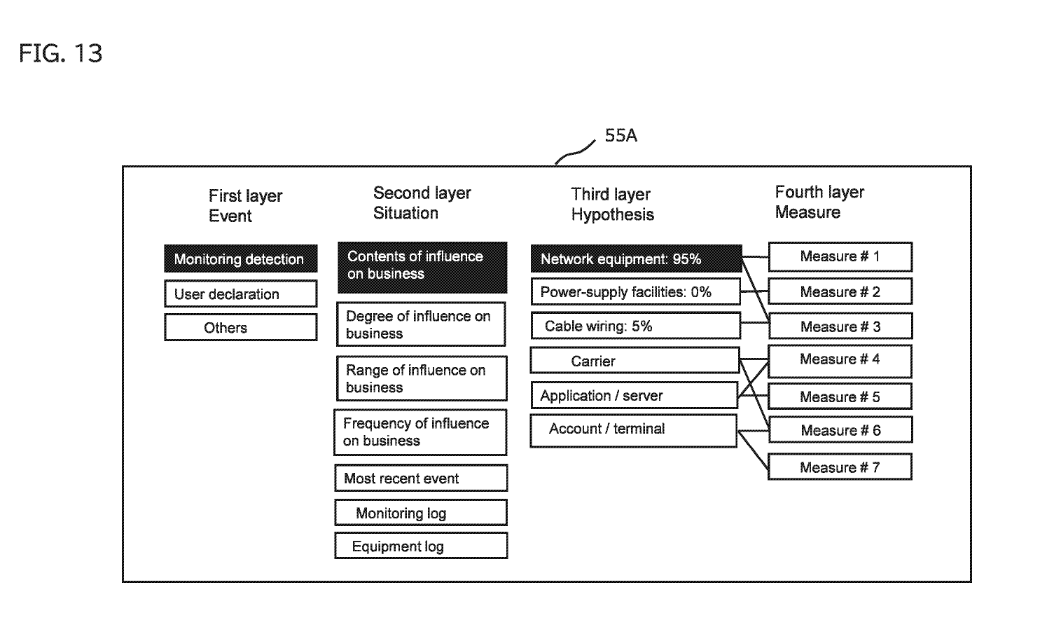

The column of the third layer "hypothesis" in the handling-process frame 55 indicates one or more hypotheses for causes prepared by the system 1 on the basis of the collected data in the situation item and a correct-answer probability of the respective hypotheses for causes (that is, a probability of being a correct answer, that is, a real cause or a degree of possibility). In this column of the third layer, there is a block indicating a plurality of hypotheses for a cause that can be prepared in relation with the event which occurred. When one or more hypotheses are prepared by the system 1, and the correct-answer probabilities of those hypotheses are calculated, a correct-answer probability is displayed in the corresponding one or more hypotheses blocks. After that, when the user selects one hypothesis as a correct answer from the prepared one or more hypotheses for causes, the selected block of hypothesis is displayed (lighted or highlighted, for example) (see FIG. 13).

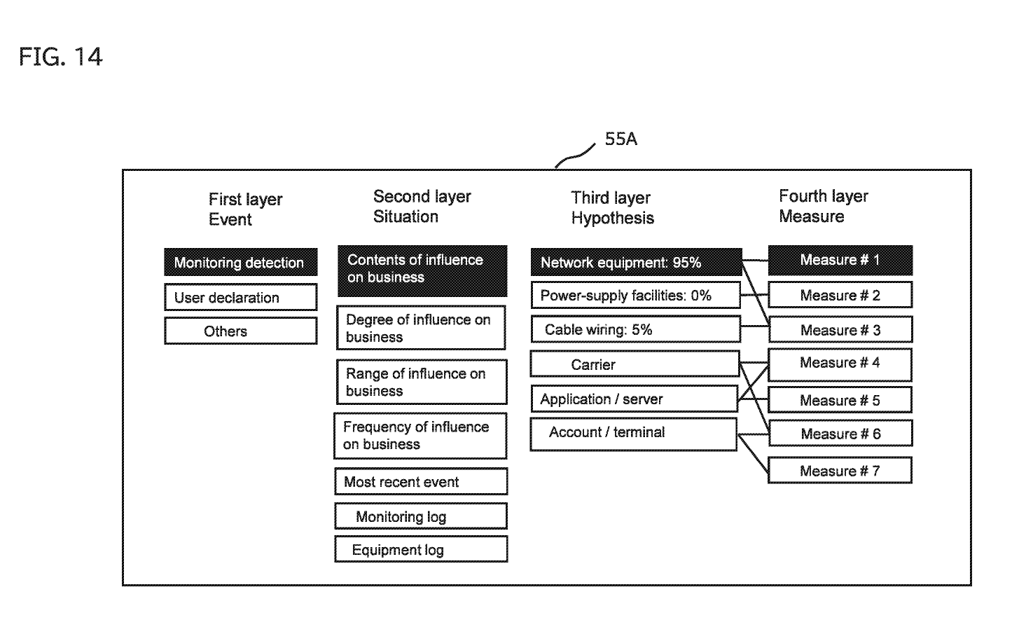

The column of the fourth layer "Measure" in the handling-process frame 55 indicates one or more measures corresponding to the cause of occurrence. In this column of the fourth layer, there is a block indicating one or more measures that can be employed in relation with the respective causes of occurrence (hypothesis for a cause) blocks. When the user selects one or more measures to be performed from those measures, the block of the measure corresponding to the selection is displayed (lighted or highlighted, for example) (see FIG. 14).

Returning to FIG. 1, the server core part 6 of the event-handling support system 1 has the database 10 and a plurality of processing modules 11 to 18.

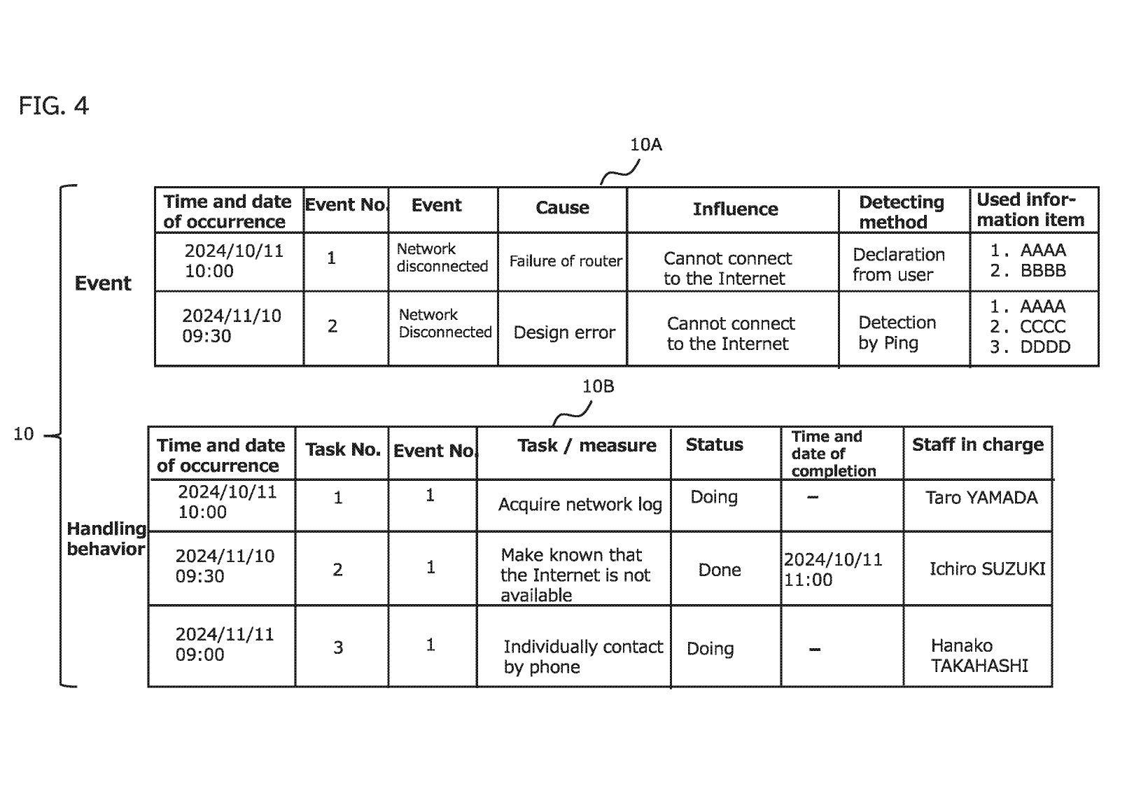

The database 10 accumulates not only the above-described inter-user communication messages but also event detailed data related to one or a plurality of events which occurred as follows. That is, the database 10 accumulates the event detailed data including various information items such as a plurality of events which occurred in the target system 2 in the past, one or more causes which caused each of those events, one or more influences provoked by each of the events, methods which detected each of the events, one or more information items used for identifying the cause of each of the events, and one or more measures taken for each of the events in the past and the like. FIG. 4 illustrates an example of a part which accumulates the event detailed data of the database 10. An upper stage in FIG. 4 illustrates an example of a part 10A of the database 10 which stores an entry corresponding to each of the events. The entries corresponding to each of the events include time and date of the occurrence, event identification numbers, events, causes, influences, fields of the detection methods and the like, for example. A lower stage in FIG. 4 illustrates an example of a part 10B of the database 10 for storing the entries corresponding to the measures related to each event. The entries related to behavior handling include time and date of the occurrence, task identification numbers, event identification numbers, tasks, statuses, time and date of completion, fields of staff in charge and the like. The event detailed data stored in the database 10 is generated by the plurality of processing modules 11 to 18 of the server core part 6 (FIG. 1), which will be described in detail below.

Returning to FIG. 1, a detection part 11 of the server core part 6 detects an event which occurred in the target system 2 by automatically monitoring the target system 2 and /or by using a result of language analysis on a natural language message by an analysis moduleanalysis module 12 exchanged among the user terminals 7 to 9 (that is, input by the user) in the database 10 and moreover, grasps the event-detailed data indicating the details related to the event.

The analysis moduleanalysis module 12 receives messages exchanged among users from the user terminals 3 to 5, analyzes the language of the respective messages, and stores the results of the analyses in the database 10. For example, the analysis moduleanalysis module 12 extracts specific words and phrases from the user message contents, and by classifying those words and phrases into a plurality of information items (events which occurred, causes, influences, services and persons affected by the influences, tasks, prospect of recovery, time and date of recovery and the like, for example), recognizes the events which occurred and the various information items related thereto. An art of classifying the words and phrases of a natural language into the various information items is realized by many elemental arts and methods which are combined. For example, it is possible to detect similar words or misused words by using Levenshtein distance or to calculate a degree of similarity in terms of meanings of the words by work vector arts such as Word2Vec, FastText and the like. In addition, necessary information can be extracted while understanding contexts by using Named Entity Recognition or a transformer model, for instance.

When the detection part 11 detects occurrence of an event, it stores what the event is in the database 10. After that, the analysis moduleanalysis module 12 stores various information items (event detailed data) related to the event grasped by the language analysis on the user message in the database 10. The Web services 3 to 5 display the event which occurred in the database 10 and the event detailed data thereof on the information-item frame 53 of the GUI 50 (FIG. 3). The analysis moduleanalysis module 12 stores the new information item in the database 10 each time new information item is obtained, and it is displayed in addition to the new information-item frame 53. As a result, the information-item frame 53 displays the detailed situation related to the event that occurred substantially on the real-time basis. Each user can grasp the details which have been found out at the current point of time of the event which occurred by referring to the information-item frame 53.

In addition, the analysis moduleanalysis module 12 detects, as a result of the language analysis on the message from the user, one or more tasks which should be performed by the user, a status of the task (before execution, during execution, execution completed or pending, for example) and stores the detected one or more tasks and the statuses thereof in the database 10. The Web services 3 to 5 display the one or more tasks in the database 10 in the task frame 54 on the GUI 50 (FIG. 3). The Web services 3 to 5 display each of the tasks at a place in the task frame 54 corresponding to the statuses thereof (To Do, Doing, Done, Pending, for example). When the analysis moduleanalysis module 12 recognizes by the language analysis on the message from the user that the current status of each task has changed, it updates the status of each task in the database 10, whereby the place of each task in the task frame 54 changes. As a result, the task frame 54 displays one or more tasks and the statuses thereof substantially on the real-time basis. Each user can grasp what task should be executed by referring to the task frame 54.

Furthermore, when the detection part 11 detects occurrence of an event, it stores the event and a detection method thereof (automatic monitoring of the target system 2, a declaration from the user, for example (that is, analysis on the message from the user) or other methods)in the database 10 and then, the Web services 3 to 5 cause by what detection method the event was detected to be displayed in the handling-process frame 55 on the GUI 50 (FIG. 3). In the example shown in FIG. 3, in the column of the "event" in the handling-process frame 55, one of the different detection method blocks of the "monitoring detection", "user declaration", "others" is caused to be displayed (highlighted display or lighted).

Returning to FIG. 1, a hypothesis preparing part 13 refers to the data accumulated in the database 10 (that is, data of various information items related to the various events which occurred and were handled in the past, and data of various information items obtained by analysis on the messages exchanged among the user terminals 7 to 9 in relation to the events which currently occur) and / or the data in the target system 2 and prepares a hypothesis of one or a plurality of causes with a possibility that caused the event which occurred in the target system 2. A correct-answer probability calculation part 14 calculates a correct answer probability indicating a probability or a possibility that each hypothesis prepared by the hypothesis preparing part 13 is correct. An additional action part 16 specifies one or more additional actions which should be performed by the user (one or more situation items which should be additionally collected by the user, for example) for narrowing, that is, for specifying one hypothesis estimated to be correct from one or more hypotheses prepared by the hypothesis preparing part 13.

There can be some different methods for constituting the hypothesis preparing part 13, the correct-answer probability calculation part 14 and the additional action part 16, but as typical method examples, a machine learning model, a deep learning model or an AI (Artificial Intelligence) model such as generative AI is used. In the following, as an example of a typical AI model, a model using a neural network is cited as an example, and processes (1) to (4) of the process example of the constitution method will be explained.

### 1. Data Preparation

In this process, by using the data in the various information items such as events, causes, situations and the like related to many events in the past accumulated in the database 10 and / or obtained from external data sources, teacher data which relates each event to the situations and the causes thereof is prepared.

### 2. Designing of Neural Network

In this process, on the basis of the data of the events which occurred and the one or more situation items collected in relation with the events, a hypothesis preparing model for preparing one or more cause hypotheses of the event is designed. In addition, on the basis of the collected data of the information items, a correct-answer probability calculation model for estimating correct-answer probabilities of the proposed one or more cause hypotheses is designed. Moreover, an additional action model for specifying an additional action which would help narrowing to any one of the prepared one or more hypotheses as a correct answer (that is, further improving the correct-answer probability of any one hypothesis) or one or more uncollected situation items which should be additionally collected, for example, is designed.

### 3. Training

In this process, by using the teacher data prepared in the above-described preparation process, the above-described hypothesis preparing model, the correct-answer probability calculation model, and the additional action model are trained and made to learn to relate the various events in the past with the situations thereof and the causes thereof. In this process, adjustment is made such that the hypothesis preparing model generates an appropriate cause hypothesis, the correct-answer probability calculation model calculates a correct-answer probability of each hypothesis with high accuracy, and the additional action model accurately specifies the additional action.

### 4. Deployment of Model

In this process, inference accuracies of the above-described hypothesis preparing model, the correct-answer probability calculation model, and the additional action model are evaluated. When the inference accuracies of those models reach a practical level, those models are deployed in the hypothesis preparing part 13, the correct-answer probability calculation part 14, and the additional action part 16 of the event-handling support system 1, respectively.

With reference to FIG. 1, a score calculation part 17 converts a degree of each of effects of the one or more additional actions specified by the additional action part 16 (that is, the result of the additional action, or if data is obtained as the result of confirmation or collection of the information item, for example, a probability that one hypothesis can be selected as a correct answer from the prepared plurality of hypotheses) into a numerical value as a score. For example, a score calculation part 17 can calculate a score by using a publicly-known statistical method. Specifically, in the plurality of hypotheses, by setting such a function that a situation with a larger difference in the correct-answer probabilities between a specific one hypothesis and another hypothesis can obtain a higher score, the score can be calculated on the basis of the function. It is to be noted that, the score has correlation with the correct-answer probability and can be expressed by a predetermined function with the correct-answer probability as a variable.

With reference to FIG. 1, the proposing part 15 generates various proposals to the user from the event-handling support system 1. The proposing part 15 stores the generated proposal in the database 10. The Web services 3 to 5 read the generated proposal from the database 10 and display it in the system-proposing frame 52 in the GUI 50 (FIG. 3) substantially on the real-time basis. There can be various displayed proposals, but one example thereof is a message notifying the additional action (the situation item to be additionally collected, for example) specified by the additional action part 16. In addition, another example of the displayed proposal is a message notifying one cause hypothesis estimated to be a correct answer.

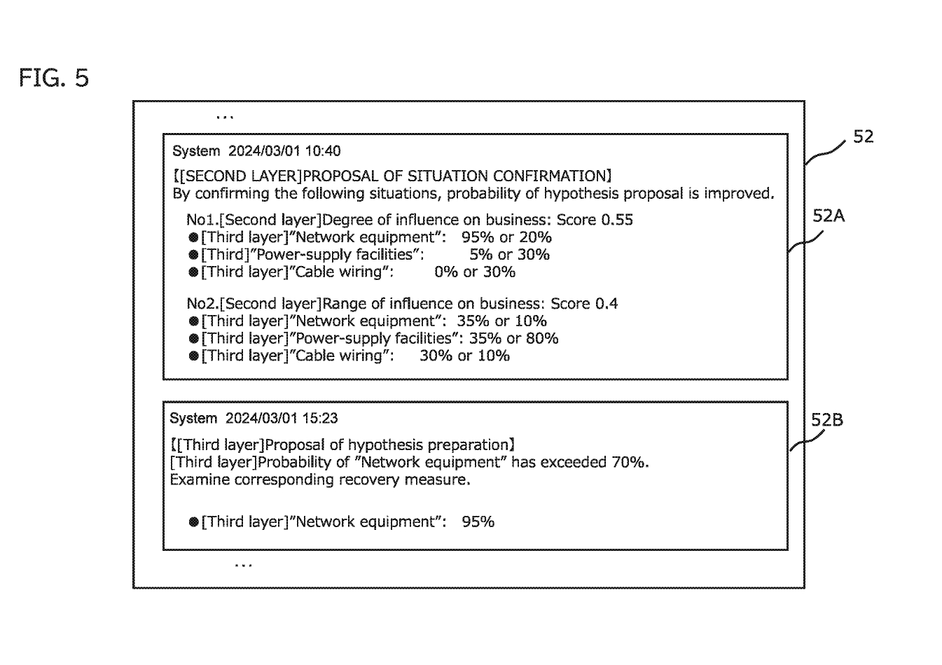

FIG. 5 illustrates a specific example of two types of proposals from the system displayed in the system-proposing frame 52. This example is based on a case in which three cause hypotheses ("network equipment", "power-supply facilities", "cable wiring") are prepared by the hypothesis preparing part 13, and correct-answer probabilities of 35%, 35% and 30% were calculated for those three hypotheses as exemplified in FIG. 1. A first proposal 52A exemplified in FIG. 5 notifies the user that, in order to narrow to one from these three hypotheses, two types of additional situation items ("degree of influence on business", "range of influence on business") were specified by the additional action part 16. This proposal 52A further illustrates that, while 0.55 is given as a score value indicating a probability of being able to deduce a correct answer from the three hypotheses in the first situation item "degree of influence on business", while a score 0.4, which is lower than that, is given to the second situation item "range of influence on business". Grounds for these scores are also indicated in the proposal 52A. That is, if the first situation item "degree of influence on business" (the degree of influence is larger or smaller than a predetermined condition, for example) is confirmed, for example, it is illustrated in the proposal 52A that the correct-answer probability of the first hypothesis "network equipment" changes to 95% or 20%, the correct-answer probability of the second hypothesis "power-supply facilities" changes to 5% or 30%, and the correct-answer probability of the third hypothesis "cable wiring" changes to 0% or 3%. When the user sees it and confirms the first situation item "degree of influence on business", it is known that the correct-answer probability of the first hypothesis "network equipment" becomes overwhelmingly high at 95%, and there is a high possibility that this can be selected as a correct answer. On the other hand, when the second situation item "range of influence on business" (that the range is wider or narrower than the predetermined condition, for example) is confirmed, the user will also know that the correct-answer probability of the second hypothesis "power-supply facilities" becomes considerably as high as at 80%, and there is a possibility that it can be selected as a correct answer. However, the user also understands that, if the first information item "degree of influence on business" with the higher score is confirmed first, it is possible to reach the correct answer more rapidly.

As described above, the first proposal 52A illustrates that, when the user additionally confirms or collects each of the plurality of situation items, to what value the respective correct-answer probabilities of the plurality of cause hypotheses change, and by confirming or collecting each situation item, with what degree of possibility that a cause of occurrence of an event is specified in score values. As a result, the first proposal 52A helps the user to determine which situation item should be given priority in confirmation in order to make clear the cause of occurrence of the event as fast as possible.

In addition, a second proposal 52B shown in FIG. 5 is based on a case in which, in response to the first proposal 52A, the user confirms the first situation item "degree of influence on business", inputs the result of the confirmation (such that the degree of the influence is larger than the predetermined condition, for example) into the inter-user communication frame 51 (FIG. 3), and upon the receipt of the confirmation result, the correct-answer probability calculation part 14 (FIG. 1) updates the correct-answer probabilities of the three hypotheses "network equipment", "power-supply facilities", and "cable wiring" prepared by the hypothesis preparing part 13 to 95%, 30%, 0%, respectively. In this case, the proposing part 15 refers to a predetermined threshold value (70%, for example) for selecting a correct answer, selects the first hypothesis "network equipment" having a correct-answer probability higher than the threshold value as a correct-answer candidate, and provides a proposal 52B as shown in FIG. 5 to the user. As described above, the proposal 52B helps the user's determination to narrow the cause of an event to one.

Returning to FIG. 1, when occurrence of an event is detected, as an initial motion, an initial-data collecting part 18 refers to data accumulated in the database 10 at that time and / or data in the target system 2 and automatically collects initial data which is helpful to propose a cause hypothesis of an event which occurred (an operation log, a transaction log and the like of the target system 2, for example). The information item included in the initial data may be determined in advance in accordance with a type of an event which occurred or may be determined with respect to a specific item set regardless of the type of an event which occurred. On the basis of the initial data collected by the initial-data collecting part 18, the hypothesis preparing part 13 prepares initial one or more hypotheses, and the correct-answer probability calculation part 14 calculates the correct-answer probabilities of those hypotheses. Those hypotheses and the correct-answer probabilities are, as already explained with reference to FIG. 3, displayed in the column of the third layer "hypothesis" of the handling process frame 52 of the GUI 50. After that, as already explained with reference to FIG. 5, the proposal 52A indicating the one or more situation items which were specified by the additional action part 16 and should be additionally collected or confirmed (and the score of each situation item calculated by the score calculation part 17) is displayed in the system-proposing frame 52 of the GUI 50. After that, when data of an additional situation item is collected or confirmed by the user, as already explained, the correct-answer probability calculation part 14 re-calculates, that is, updates the correct-answer probability of each hypothesis on the basis of the added data. As a result, when the correct-answer probability of one hypothesis becomes higher than the predetermined threshold value, the proposal 52B suggesting selection of the hypothesis as a correct answer as exemplified in FIG. 5 is presented. As described above, a series of handling behaviors that, when an event occurred, information which is helpful for cause investigation is collected, a cause hypothesis is set up, and the cause is made clear, which is not easy for the user, is supported.

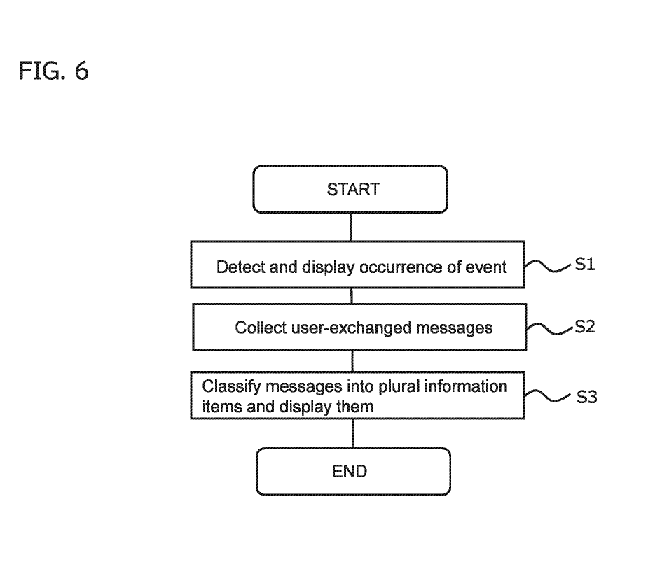

FIG. 6 is a flowchart illustrating a processing process for detecting an event and for interpreting an inter-user message executed by the event-handling support system 1 according to the embodiment.

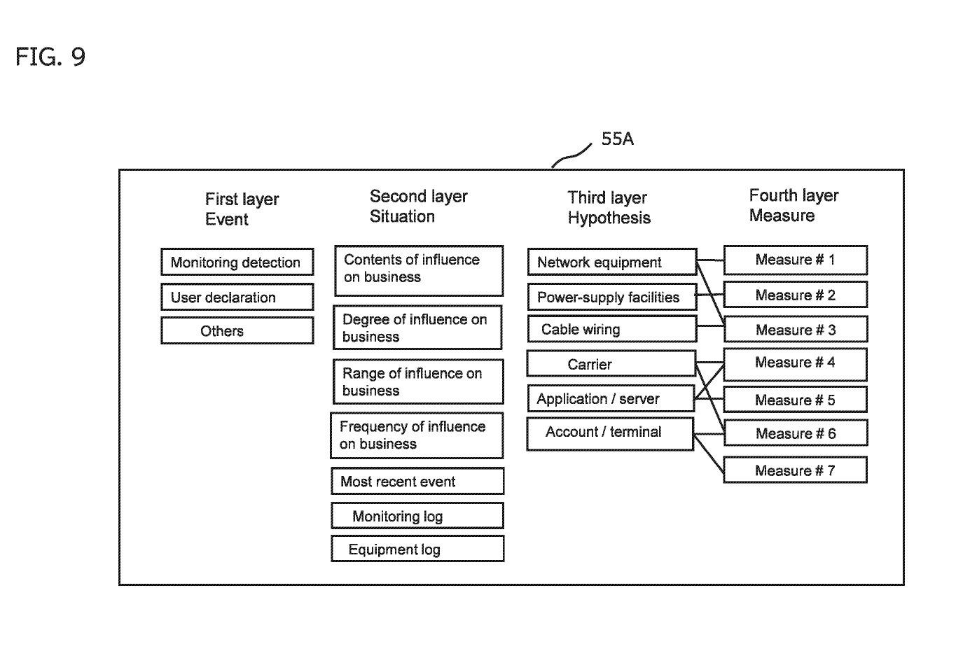

At Step S1, the detection part 11 detects occurrence of an event and stores event-detection data indicating what event occurred at what time in the database 10. As a detection method of occurrence of an event, there can be a method of automatically monitoring the target system 2, a method of detection based on a declaration from a user, and the other methods. An example of the method of detection based on the declaration from the user is a method of using the Steps 2 to 3, in which a natural language message of the user input from the user terminals 7 to 9 is analyzed by the analysis moduleanalysis module 12, what event has occurred is automatically recognized, and the recognition result is stored as the event-detection data in the database 10. In accordance with the event-detection data in the database 10, the Web services 3 to 5 display the natural language message indicating what event occurred at what time in the communication frame 51 in the GUI 50 (FIG. 3) on the real-time basis. In addition, the Web services 7 to 9 display by what method the event which occurred was detected on the first layer "event" in the handling-process frame 55 of the GUI 50 (FIGS. 3, FIG. 9).

After the event was detected, the users make clear the cause of the event with each other via the user terminals 7 to 9, determine on the measure and start a discussion to perform measure behaviors. While the discussion continues, at Step S2, the analysis moduleanalysis module 12 collects the users' messages (type-input texts or spoken voices) exchanged among the user terminals 7 to 9. When a message is voices in a conversation, the analysis moduleanalysis module 12 converts the voices to texts. The analysis module 12 stores text data of the collected inter-user messages in the database 10. The Web services 7 to 9 display those inter-user messages in the user communication frame 51 of the GUI 50 on the real-time basis. With elapse of time, new messages are exchanged among the users, and at each communication, Step S2 is repeated, and the new messages are added to the database 10 and the inter-user communication frame 51.

At Step S3, the analysis module 12 analyzes each of the collected messages, extracts words and phrases included in the messages, and classifies those words and phrases into the plurality of information items determined in advance (events which occurred, causes, situations, affected persons, tasks and the like, for example). As a result, the analysis module 12 recognizes the various matters which relate to the events which occurred, causes thereof, situations, influences, tasks and the like which are helpful for handling of the events from the messages of the users. The analysis module 12 stores those recognized matters in the database 10. The Web services 7 to 9 read those recognized matters from the database 10, organize those matters and display them in a list format, for example, in the information-item frame 53 of the GUI 50 (in the case of the matters related to the task, in the task frame 54) on the real-time basis. As time elapses, a new user message is added, Step S3 is repeated each time, a new matter is recognized, and the new matter is added to the information-item frame 53 and the task frame 54.

The processes of the above-described Steps S2 to S3 are repeatedly executed continuously until the processing of the events which occurred by the users have completed, whereby transition of event handling is notified to the user via the GUI 50 on the real-time basis.

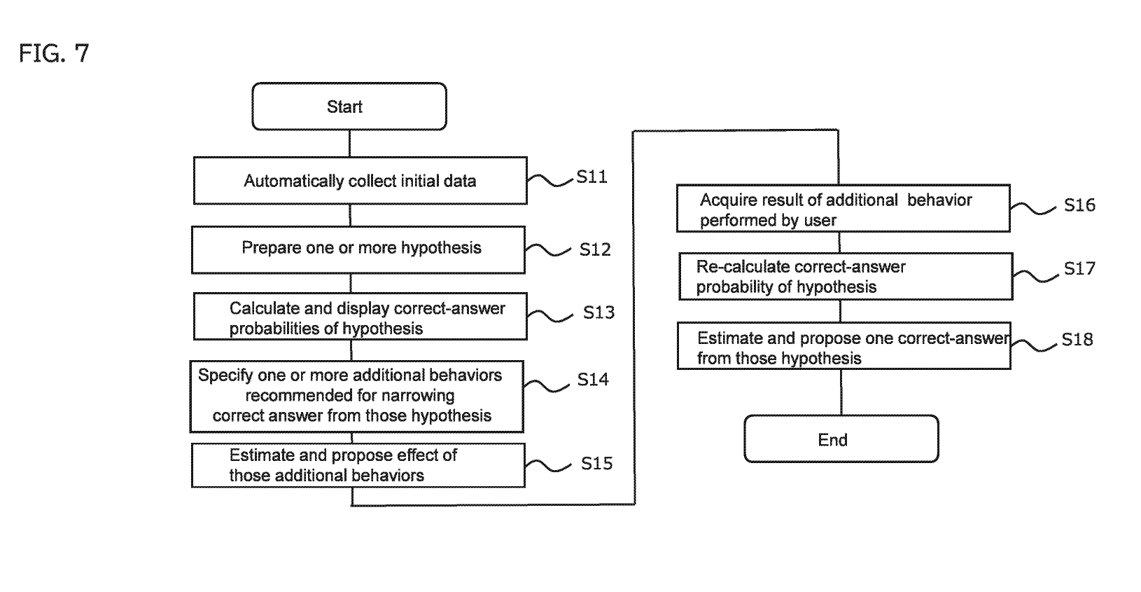

FIG. 7 is a flowchart illustrating a processing process for investigating the cause of occurrence of the event executed by the event-handling support system 1 according to the embodiment.

In response to the detection of occurrence of an event, at Step S11, the initial-data collecting part 18 automatically collects data which is helpful in cause investigation of the event which occurred from the target system 2, the database 10 and / or an external data source (hereinafter referred to as initial data) and stores the initial data in the database 10. The initial data may include information such as vulnerability and the like made public in the Internet, information for analysis and detection of attacks such as IoC (Indicator of Compromise) and IoA (Indicator of Attack), configuration management information such as configuration diagrams, designs, manuals and the like of target systems and their sub-systems and related systems, know-how information accumulated in a knowledge sharing system such as internal Wiki constructed during planning / development / maintenance and operation of the other target systems. Details of the initial data (causes of the past events of the same type in the database and specific types of logs of the target system 2, specific situation items used for investigation of the causes and the like, for example) may be determined in advance in accordance with the type of the event which occurred or regardless of the type of the event.

At Step S12, the hypothesis preparing part 13 estimates a hypothesis of one or more (usually a plurality of) causes which caused the event by using the initial data. The prepared hypothesis is stored in the database 10.

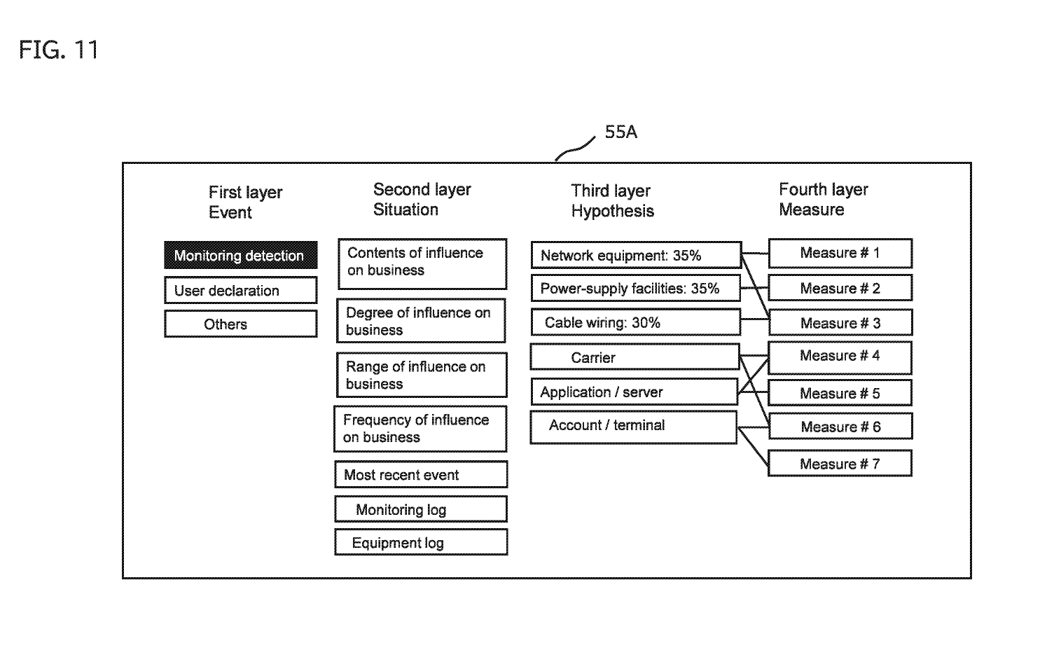

At Step S13, the correct-answer probability calculation part 14 calculates a correct-answer probability indicating a possibility that each hypothesis is a correct answer (that is, a true cause) for each of the prepared hypotheses. The calculated correct-answer probability for each hypothesis is stored in the database 10. The Web services 7 to 9 display the prepared one or more hypotheses and their correct-answer probabilities in the third layer "hypothesis" of the handling-process frame 55 of the GUI 50 (FIG. 3, FIG. 11).

At Step S14, the proposing part 15 specifies one or more additional actions which are recommended to be further performed by the user for narrowing to one correct answer from the prepared hypotheses. Here, a typical example of an additional action is confirmation or collection of the additional situation item (a situation item which has not been confirmed or collected yet, for example, and if it is confirmed or collected, there is a possibility that a difference between the correct-answer probability of any one hypothesis and that of another hypothesis might become larger). The proposing part 15 stores those additional actions in the database 10.

At Step S15, for each of those additional actions, the proposing part 15 estimates what effect will be obtained in order to narrow down a correct answer, if the user performs the additional action. Here, one typical example of the effect is a correct-answer probability of each hypothesis predicted as a result of the performance of the additional action. Here, a predicted correct-answer probability can be obtained by providing, to the correct-answer probability calculation part 14, the collected data including the initial data and the data which would be obtained by performing the additional action and by causing it to re-calculate a correct-answer probability of each hypothesis. Another typical example of the effect of the additional action is a score of the additional action (that is, a degree of possibility that a correct answer can be narrowed, which is predicted by performing the additional action) as exemplified in the first proposal 52A in FIG. 5. The proposing part 15 can calculate a score of each additional action by applying the correct-answer probability of the hypothesis re-calculated for each additional action to a predetermined calculation formula. And the proposing part 15 generates a proposal (as the first proposal 52A in FIG. 5, for example) indicating those additional actions and their effects (the correct-answer probability of the hypothesis and the score of the additional action, for example). The proposal indicating the one or more additional actions and their effects generated as above is stored in the database 10. The Web services 7 to 9 display the proposal stored in the database 10 in the system-proposing frame 52 of the GUI 50.

When any one of the users performs any one of the additional actions indicated in the above-described proposal (or performs an arbitrary additional action not indicated in the above-described proposal), and when a message indicating the result of the performed additional action (result of the confirmation or collection of the additional situation item, for example) is input from any one of the user terminals 7 to 9, at Step S16, the analysis module 12 analyzes the message and recognizes the above-described result. The result of the recognized additional action is stored in the database 10.

At Step S17, the correct-answer probability calculation part 14 adds the result of the recognized additional action into consideration and re-calculates the correct-answer probability of each hypothesis. Those re-calculated correct-answer probabilities are stored in the database 10. The Web services 7 to 9 update the correct-answer probability of each of the hypotheses displayed in the handling-process frame 55 of the GUI 50 to a re-calculated correct-answer probability.

At Step S18, the proposing part 15 tries to estimate one correct answer from those hypotheses on the basis of the re-calculated correct-answer probability of each hypothesis. As a method for estimation, various methods can be employed. For example, a method that one hypothesis having the largest correct-answer probability equal to or larger than a predetermined threshold value (70%, for example) is estimated to be a correct answer can be employed. Alternatively, a method that one hypothesis having a correct-answer probability equal to or larger than a predetermined first threshold value (70%, for example) and equal to or larger than another hypothesis by a second threshold value (30%, for example) is estimated to be a correct answer may be employed. When one correct answer can be estimated, the proposing part 15 indicates the estimated correct answer as the second proposal exemplified in FIG. 5 and generates a proposal which promotes performance of a measure and stores it in the database 10. The Web services 7 to 9 display the proposal in the system-proposing frame 52 of the GUI 50.

When one correct answer cannot be estimated in the trial at Step S18, the processes at Steps S14 to S18 or the processes at Steps S12 to S18 may be repeated. As a result, more additional actions which are helpful to specify a correct answer is proposed to the user, the correct-answer probability of the hypothesis is updated in accordance with the result of the additional action, and the selection of the correct answer is made more accurate. In addition, the user can voluntarily perform additional actions such as confirmation, collection and the like of arbitrary information items, regardless of presence / absence of a proposal from the system 1. When a message indicating the result of the voluntary additional action of the user as above is input from the user into the system 1, the above-described result recognized from the message is newly added to the consideration, and the processes at Steps S14 to S18 or the processes at Steps S12 to S18 may be repeated.

A control process illustrated in FIG. 7 helps the user to take a swift and accurate performance of cause investigation of the event which occurred. It is to be noted that, in the process in FIG. 7, two types of the proposals 52A, 52B exemplified in FIG. 5 are presented from the system 1 to the user, but it is possible to provide other types of proposals to the user. For example, when a cause of occurrence of an event is specified (a hypothesis of one correct answer is specified), it is possible that the system 1 automatically selects one or more measures for removing or solving a harmful result by the cause or the event and proposes those measures to the user. As a method of selecting a measure to be proposed, a measure determined in advance for each cause may be selected, or on the basis of the data of various types of collected situation items, those with higher appropriateness may be selected with priority from a plurality of measure candidates. Alternatively, the control process may be constituted such that one or more recommended measures are automatically generated in accordance with the specified cause of occurrence. That can be realized, for example, by using a machine learning model, a deep learning model or a generative AI model which learned a method of generating a measure from the cause of occurrence.

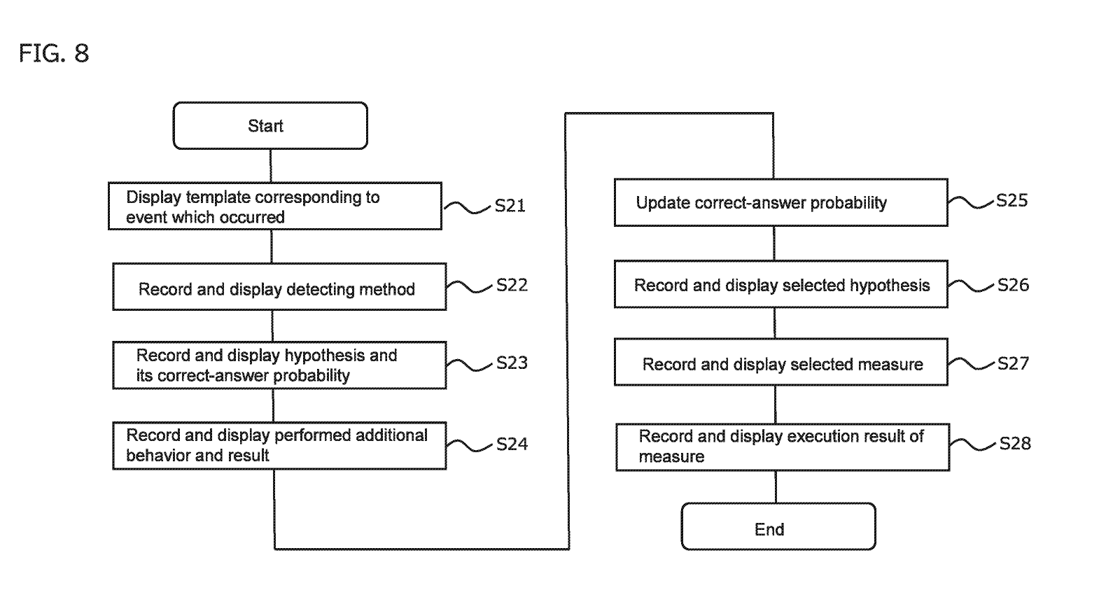

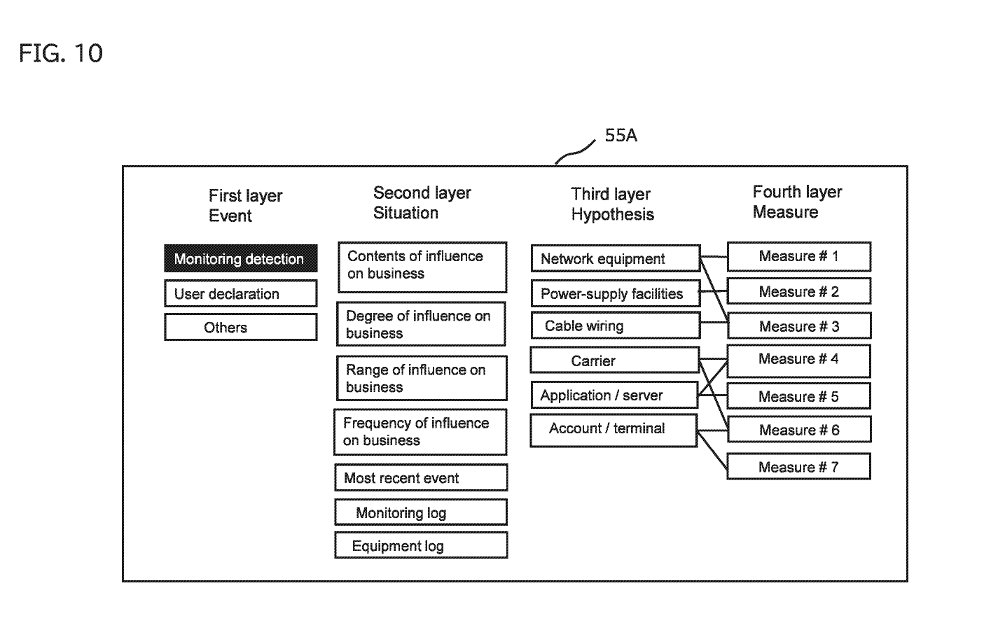

FIG. 8 is a flowchart illustrating a processing process for presenting progress of event-handling performed by the event-handling support system 1 according to the embodiment to the user. FIG. 9 illustrates an example of a template of the event-handling process. FIGS. 10 to 14 illustrate display examples of the handling-process frame 55 of the GUI 50, which changes with progress of the process shown in FIG. 8.

With reference to FIG. 8, when occurrence of an event is detected, at Step S21, from various templates of the event-handling process prepared in advance and corresponding to each of various events which occurred, a template 55A corresponding to the event which occurred is selected and displayed in the handling-process frame 55. FIG. 9 illustrates an example of the selected template 55A. As shown in FIG. 9, in the template 55A, an entire image of the event-handling process is expressed by a chart (a block diagram, for example) including four layers of "event", "situation", "hypothesis", and "measure", for example. In the first layer "event", a plurality of types of detection methods with a possibility of detection of the event which occurred are listed. In the second layer "situation", a plurality of types of situation items with a possibility of helping the cause investigation of the event which occurred are listed. In the third layer "hypothesis", a plurality of types of causes with a possibility of causing the event which occurred (cause hypotheses) are listed. In the fourth layer "measure", a plurality of types of measures with a possibility of removing the cause of the event which occurred or solving a bad influence or a harmful result are listed. Each of the causes in the third layer and the one or more measures in the fourth layer, which are effective for each cause, are related with each other by line segments. By looking at the template 55A as above, even a user with little experience or knowledge on handling of an event can easily know various options of the handling methods for the event which occurred.

Returning to FIG. 8, when the occurrence of the event is detected, at Step S22, the method which detected the event which occurred is stored in the database 10 and is displayed in the first layer "event" of the handling-process frame 55. FIG. 10 illustrates a display example thereof, and in this example, the "monitoring detection" (that is, the fact that the event was automatically detected by monitoring the target system 2) is shown.

Returning to FIG. 8, when one or more cause hypotheses of the event which occurred are prepared, and the correct-answer probabilities of those hypotheses are calculated, at Step S23, the prepared hypotheses and their correct-answer probabilities are stored in the database 10 and displayed in the third layer "hypothesis" of the handling-process frame 55. FIG. 11 illustrates a display example thereof, and in this example, three hypotheses "network equipment", "power-supply facilities", and "cable wiring" are prepared, and it is shown that the respective correct-answer probabilities thereof are 35%, 35%, and 30%. In this display example, a hypothesis for which the correct-answer probability is not displayed is not prepared (it was determined by the system 1 that there is no possibility of being a cause).

Returning to FIG. 8, when the user performs an additional action (confirmation or collection of the additional situation item, for example) and inputs a message indicating the result, at Step S24, the performed additional action and the result thereof are recognized and stored in the database 10, and the performed additional action is displayed in the second layer "situation" of the handling-process frame 55. FIG. 12 shows a display example thereof, and in this example, it is illustrated that the collection or confirmation of the situation item "contents of influence on business" was performed, and the result thereof was input.

Returning to FIG. 8, when the correct-answer probability of the hypothesis is re-calculated in accordance with the result of the performed additional action, at Step S25, the re-calculated correct-answer probability is stored in the database 10, and the correct-answer probability of the hypothesis displayed in the third layer "hypothesis" of the handling-process frame 55 is updated to the re-calculated value. FIG. 12 shows a display example thereof, and in this example, the correct-answer probabilities of the three hypotheses, that is, "network equipment", "power-supply facilities", and "cable wiring" are updated to 95%, 0%, and 5%. The updated correct-answer probabilities help the user to specify a correct cause.

Returning to FIG. 8, when the user selects one hypothesis in the handling-process frame 55 as a correct answer, at Step S26, the selected hypothesis is stored in the database 10 and is displayed in the third layer "hypothesis" of the handling-process frame 55. FIG. 13 shows a display example thereof, and in this example, it is illustrated that the hypothesis "network equipment" was selected. And as shown in FIG. 3, it is illustrated that, as a measure against the selected hypothesis (that is, the cause specified by the user) "network equipment", there are two methods of "measure #1" and "measure #2". The display as above helps the user to select an appropriate measure.

Returning to FIG. 8, when the user selects one or more measures in the handling-process frame 55 as the behaviors to be performed, at Step S27, the selected measure is stored in the database 10 and is displayed in the fourth layer "measure" of the handling-process frame 55. FIG. 14 illustrates a display example thereof, and in this example, it is shown that the "measure #1" was selected.

Returning to FIG. 8, when the user inputs a message indicating the result of the user's performance of the above-described selected measure (such that it was successful or failed to solve the event or the like, for example) from the user terminal, at Step S28, the performance result of the measure is recognized and stored in the database 10 and is displayed in the fourth layer "measure" of the handling-process frame 55.

It is to be noted that, when the result of performance of one measure failed, the user can select another measure from the list of the fourth layer "measure" of the handling-process frame 55. In that case, with respect to the control illustrated in FIG. 8, Steps S27 to S28 are repeated for the selected measure.

As described above, the handling-process frame 55 of the GUI 50 lists various handling behaviors that can be employed at a plurality of stages such as the various handling behaviors that can be employed by the user for the event which occurred or to be concrete, collection of related information, preparing of a hypothesis based on the collected information, specification of a true cause from those hypotheses, and selection of a measure conforming to the specified cause. And the handling-process frame 55 displays the current state of the progress of the event-handling process on a real-time basis. This helps the users to specify the cause of occurrence of the event accurately and rapidly and to take the measures.

The present invention is not limited to the above-described embodiment but includes various variations. For example, the above-described embodiment is explained in detail in order to explain the present invention easily to be understood and does not necessarily limit to those including all the explained configurations. In addition, a part of the configuration of an example can be replaced with the configuration of another embodiment or a configuration of another embodiment can be also added to the configuration of an embodiment. In addition, it is possible to add / delete / replace a part of the configuration of each embodiment to / from / with the other configuration.

What is claimed is:

1. An event-handling support system for supporting a user who performs handling of an event which occurred in a target system, the event-handling support system comprising:
a communication module configured to communicate with a user terminal used by the user;
a detection module configured to detect an event which occurred in the target system;
an analysis module configured to receive a message of the user from the user terminal and to execute language analysis on the received message;
a data collection module configured to collect data which can be used for investigating a cause of the event which occurred;
a hypothesis module configured to prepare one or more hypotheses indicating one or more causes with a probability of causing the event, which occurred, by using the collected data and a result of the language analysis on the message; and
a user interface (UI) module configured to notify the user of occurrence of the event and the one or more hypotheses.

2. The event-handling support system according to claim 1, further comprising:
an additional action module configured to specify one or more additional actions which are helpful to narrow to one correct answer from the one or more hypotheses; and
a proposing module configured to prepare a first proposal including presentation of the one or more specified additional actions, wherein
the UI module configured to notify the user of the first proposal.

3. The event-handling support system according to claim 2, further comprising:
a probability module configured to calculate a correct-answer probability of the one or more hypotheses; and
the UI module configured to notify the user of the correct-answer probability of the one or more hypotheses.

4. The event-handling support system according to claim 3, wherein,
the analysis module is configured to, when the analysis module receives a new message indicating a result of an additional action performed by the user from the user terminal, execute language analysis on the new message and recognize the result of the performed additional action;
the probability module is configured to re-calculate a correct-answer probability of the one or more hypotheses by using the recognized result; and
the UI module is configured to update the correct-answer probability of the one or more hypotheses notified to the user in accordance with a result of the re-calculation.

5. The event-handling support system according to claim 3, wherein
the analysis module is configured to, when the analysis module receives a new message indicating a result of an additional action performed by the user from the user terminal, execute language analysis on the new message and recognize the result of the performed additional action;
the probability module is configured to re-calculate a correct-answer probability of the one or more hypotheses by using the recognized result;
the proposing module is configured to determine whether a correct-answer probability of the one or more hypotheses calculated by the probability module satisfies a predetermined condition, and when a determination result is positive, to estimate one correct answer from the one or more hypotheses, and to generate a second proposal including presentation of the estimated one correct answer; and
the UI module is configured to notify the user of the second proposal.

6. The event-handling support system according to claim 2, further comprising:
a probability module configured to calculate a correct-answer probability of the one or more hypotheses, wherein
the UI module is configured to notify the user of the correct-answer probability of the one or more hypotheses;
the probability module is configured to predict how the correct-answer probability changes, when a result of performance of each of the one or more additional actions is obtained; and
the proposing module is configured to add presentation of a predicted change of the correct-answer probability to the first proposal.

7. The event-handling support system according to claim 2, further comprising:
a score module configured to calculate a score of an effect for specifying the correct answer from the one or more hypotheses of each of the one or more additional actions, wherein
the proposing module is configured to add presentation of each of the scores of the one or more additional actions to the first proposal.

8. The event-handling support system according to claim 2, wherein
the analysis module is configured to, when the analysis module receives a new message indicating a result of an additional action performed by the user from the user terminal, execute language analysis on the new message and recognizes the result of the performed additional action;
the probability module is configured to re-calculate a correct-answer probability of the one or more hypotheses by using the recognized result;
the proposing module is configured to determine whether correct-answer probabilities of the one or more hypotheses calculated by the probability module satisfy a predetermined condition, and when a determination result is positive, to estimate one correct answer from the one or more hypotheses, and to prepare a second proposal including presentation of the estimated one correct answer; and
the UI module is configured to notify the user of the second proposal.

9. The event-handling support system according to claim 8, wherein
the UI module is configured to provide, to the user terminal, GUI including display of a chart expressing an event-handling process;
the chart has first, second, third, and fourth layers;
the first layer displays a fact that the event which occurred is detected;
the second layer lists a plurality of additional actions with a possibility of helping investigation of a cause of the event which occurred;
the third layer lists a plurality of hypotheses related to a cause with a possibility of causing the event which occurred, and
the fourth layer lists one or more measures related to each of the plurality of listed hypotheses.

10. The event-handling support system according to claim 9, wherein, the UI module:
when the one or more hypotheses are prepared, displays the one or more prepared hypotheses on the third layer;
when the result of the additional action performed by the user is recognized, displays the performed additional action on the second layer;
when one hypothesis estimated to be a correct answer is selected by the user from the one or more hypotheses, displays the one selected hypothesis on the third layer; and
when one or more measures are performed by the user, displays the one or more performed measures on the fourth layer.

11. The event-handling support system according to claim 1, wherein
the UI module is configured to provide, to the user terminal, GUI including display of a message of the user from the user terminal.

12. The event-handling support system according to claim 1, wherein
the UI module is configured to provide, to the user terminal, GUI including display of a result of the language analysis on a message of the user.

13. An event-handling support system for supporting a user who performs handling of an event which occurred in a target system, the event-handling support system comprising:
a computer including:
a processor capable of executing a program set; and
a storage having the program set, wherein
the program set gives orders to the processor:
to communicate with a user terminal used by the user;
to detect an event which occurred in the target system;
to conduct, upon receipt of a message of the user from the user terminal, language analysis on the received message;
to collect data capable of being used for cause investigation of the event which occurred;
to prepare one or more hypotheses indicating one or more causes with a possibility of causing the event which occurred by using the collected data and a result of the language analysis on the message; and
to notify the user of occurrence of the event and the one or more hypotheses.
